(19) United States
(12) Patent Application Publication
(10) Pub. No.: US 2009/0248384 A1
(43) Pub. Date: Oct. 1, 2009

(54) PROCESS CONTROL SYSTEM IN AN AUTOMATION INSTALLATION

(75) Inventor: Michael Gienke, Hannover (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/407,364

(22) Filed: Mar. 19, 2009

(30) Foreign Application Priority Data
Mar. 28, 2008 (DE) 10 2008 016 048.2

(51) Int. Cl. G06F 17/50; G06F 13/14

(52) U.S. Cl. 703/14; 710/305

(57) ABSTRACT

A process control system is disclosed in an automation installation having field devices which are networked by means of a system bus and which can be operated using associated system control units which are connected by means of a terminal bus to at least one central engineering computer for configuring the system and to a central control station for monitoring and operating the system. For the purpose of linking at least one extraneous control unit to the terminal bus an interposed control computer is proposed which, under software control, simulates a system-compliant I/O unit on the terminal bus, which I/O unit is bi-directionally connected to an OPC client residing on the extraneous control unit.

### RELATED APPLICATION

This application claims priority under 35 U.S.C. §119 to German Patent Application No. 10 2008 016 048.2 filed in Germany on Mar. 28, 2008, the entire content of which is hereby incorporated by reference in its entirety.

### TECHNICAL FIELD

The present disclosure relates to a process control system in an automation installation having field devices which are networked by means of a data bus and which can be operated using associated system control units which are connected by means of a system bus to at least one central engineering computer for configuring the system and to a central control station for monitoring and operating the system. In addition, the disclosure also relates to a control computer which is used as part of this system, to a method for the software-controlled operation thereof and to a computer program product, together with a data storage medium, which is related thereto.

The field of application of the present disclosure extends to automation installations, for example in the food industry, the pharmaceutical industry, the automotive industry and the like. A process control system is used for managing the installation and typically comprises what are known as process-level components and also operating and observation stations. The process-level components primarily control actuators, such as motors, pressure medium cylinders and the like, and record measured values. The operating and observation stations are used primarily for user management, installation visualization and, quite particularly, for global installation control. Operating and observation stations are, by way of example, engineering computers for configuring the system and also central control stations for monitoring and operating the system.

The various components of the system communicate with one another as stipulated by a defined connection architecture. The most common architectures are single-bus architecture and server architecture. In the case of the single-bus architecture, all components in the process control system are strung onto one data bus. This allows any operating and observation station to tap off the desired data from any process-level component and in turn to give commands thereto. This architecture can have a high level of availability; a drawback is the often high bus load in the case of large installations. For this case, the server architecture is primarily used. In a server architecture, there are usually two different bus systems. While a system bus connects the process-level components to associated system control units, a terminal bus connects all the operating and observation stations to the various system control units. The system control units commanding the field devices cyclically gather the desired data from all the field devices and make said data available to the operating and observation stations via the terminal bus. The separate bus systems can allow good scaling of the bus load and simple intervention for extraneous applications by the server is possible. Often, hybrid versions of the architecture presented above are also used. The present disclosure can be used primarily as part of the server architecture for relatively large automation installations.

### BACKGROUND INFORMATION

WO 2006/092382 reveals the design and operation of a process control system of the generic type. An engineering system is used to store the data required for developing and configuring an automation installation, with the engineering system automatically ascertaining maintenance-related information from a project-oriented automation installation as required by the user, said information being able to be presented in a diagnosis area of the engineering system on a visual display device. The components of the automation installation, particularly the field devices, are represented by suitable symbols in hierarchically structured images, and the maintenance-related data are associated therewith. This allows the user at the level of the operating and observation stations of the process control system to use the central engineering computer, which provides the aforesaid functionality, to configure the entire system in convenient fashion.

During the configuration of process control systems, it frequently arises that components, for example field devices, from third-party manufacturers need to be integrated into the process control system. To allow these components from third-party manufacturers to be integrated into the control of the process control system as seamlessly as possible, the prior art requires the provision of specific communication gateways as an interface. Such communication gateways can be programmed in the form of software. It is likewise possible to implement mapping components in the process control system control software which needs to be configured by the user.

### SUMMARY

A process control system is disclosed into which components from third-party providers which are not system-compatible per se can be flexibly integrated with little sophistication.

A process control system in an automation installation is disclosed having field devices which are networked by means of a system bus and which can be operated using associated system control units which are connected by means of a terminal bus to at least one central engineering computer for configuring the system and to a central control station for monitoring and operating the system, wherein for the purpose of linking at least one extraneous control unit to the terminal bus an interposed control computer is provided which, under software control, simulates a system-compliant I/O unit on the terminal bus, which I/O unit is bi-directionally connected to a software interface residing on the extraneous control unit.

Various exemplary methods, computer program products and data storage media are disclosed based on such a system.

### BRIEF DESCRIPTION OF THE DRAWINGS

Further measures improving the disclosure are illustrated in more detail below, together with the description of an exemplary embodiment of the disclosure, with reference to the figures, in which:

FIG. 1 shows a schematic block diagram of a process control system with integrated extraneous control units, and

FIG. 2 shows an illustration of a component from the process control system shown in FIG. 1 in block diagram form.

### DETAILED DESCRIPTION

The disclosure encompasses the system-based teaching that for the purpose of linking extraneous control units to the terminal bus an interposed control computer is provided which, under software control, simulates a system-compliant I/O unit on the terminal bus, which I/O unit is bi-directionally connected to a software interface, subsequently referred to as an OPC client, residing on the extraneous control unit.

The simulation of the I/O unit in the control computer, which is the interface between extraneous control unit and terminal bus, provides the prerequisite for seamlessly integrating an extraneous control unit in simple fashion from the point of view of data engineering. This prerequisite is employed by an OPC client coupled to the I/O unit. OPC (OLE for process control) is a standard interface and is based on the component model of the Microsoft® company. The term “OLE” (Object Linking and Embedding) has been used intermittently for the entire component architecture. The OPC interface is fully in the software running on a PC as a platform for operating and observation systems or other applications, is situated beneath the application program and is fully implemented by software. Hence, OPC does not compete with bus systems such as the PROFIBUS but rather connects application programs and subassembly drivers on a PC (personal computer) to one another. It is cited here as a representative of an Application Programming Interface for accessing the extraneous control unit.

As a representation of the disclosure, the OPC interface is used between the data acquisition system in the form of the simulated I/O unit on the terminal bus and the extraneous control unit as a device-specific data provider. The OPC client can be connected to one or more OPC servers by PROFIBUS, CAN-BUS or the like. The OPC server is provided by a manufacturer as a kind of service provider for accessing data, for example in order to set up access to a programmable logic controller. Since the nature of the data access is the same for all OPC servers, it is possible to exchange an OPC server for a product from a different manufacturer with comparatively little sophistication, which forms the prerequisite for connecting various extraneous control units to a terminal bus in a process control system with little sophistication within the context of the present disclosure.

In addition, the solution based on the disclosure can allow, in principle, extraneous control units from third-party providers to be connected in the same way as original system control units. If required, additional control logic can be executed on the system-compliant I/O unit simulated in line with the disclosure. In this respect, the solution based on the disclosure can be customized to different requirements of the user.

In other words, the disclosure equips the process control system with a software controller, a software program that simulates the behavior of a system control unit using a PC. In this case, all the requisite mapping functions take place within the software controller, in exactly the same way as function blocks which are executed within the controller in the field. To lower the sophistication of configuration, the software controller representing the disclosure preferably supports the type and instance relationships of the process control system. This dispenses with prior definitions of object types for objects of the extraneous control unit.

In line with one measure improving the disclosure, it is proposed that the OPC client integrated in the control computer have an associated OPC server, likewise directly integrated therein at the same time, as a communication interface to the extraneous control unit. In this respect, the OPC server can at the same time advantageously be operated by the same hardware.

The solution based on the disclosure can also be embodied as a computer program product which, when running on a processor in the interposed control computer representing the disclosure, uses software to instruct the processor to perform the associated method steps representing the disclosure.

In this connection, a computer-readable medium is also part of the subject matter of the disclosure, said medium storing a computer program product as described above in retrievable form.

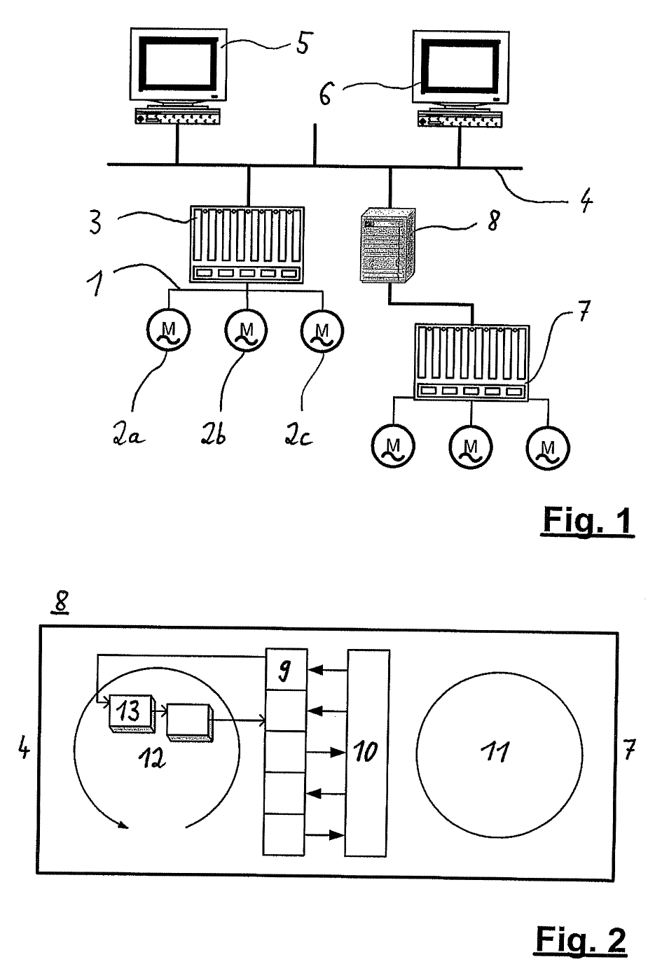

As shown in FIG. 1, the process control system in an automation installation essentially comprises a plurality of field devices 2a to 2c which are networked by means of a system bus 1 and which, in this exemplary embodiment, are in the form of electric motors. A control unit 3, which is likewise arranged on the system bus 1, is used to make the connection to a terminal bus 4. For the purpose of configuring the system, the terminal bus 4 additionally has an engineering computer 5 connected to it too. For the purpose of monitoring and for the purpose of operating the system, a central control station 6 is connected to the terminal bus 4.

The process control system also has an extraneous control unit 7 connected to it which comes from a different manufacturer than the system control unit 3. In this respect, the extraneous control unit 7 has different connection conditions. For the purpose of linking the extraneous control unit 7 to the terminal bus 4, a control computer 8 is interposed.

As shown in FIG. 2, the control computer 8, which is shown here in block diagram form and is representationally in the form of a personal computer (PC), contains, on the terminal bus 4, an I/O unit 9 which is compliant with the process control system and which is simulated by software. On the extraneous control unit 7, an OPC client 10 is shown, likewise by software. The I/O unit 9 and the OPC client 10 effect bi-directional data interchange between them so that the extraneous control unit 7 can be operated as a dedicated system control unit using the process control system.

The OPC client 10 integrated in the control computer 8 has an associated OPC server 11, likewise integrated therein, as a communication interface to the extraneous control unit 7. On the terminal bus 4, a control logic unit 12 caters for execution of function blocks 13 via the I/O unit 9, which for its part handles the bi-directional data interchange with the OPC client 10 on an interface basis for the purpose of linking the extraneous control unit 7.

Furthermore, provision may be made for alarms to be produced in the control logic unit 12. If the extraneous system does not provide a mechanism for accessing alarm conditions detected in the extraneous control unit 7, for example infringement of limit values in the process, said alarm conditions are therefore provided on the operating stations.

Furthermore, provision may be made for necessary transformations for the purpose of correctly presenting the data from the extraneous control unit 7 in the control system to be performed by applications in the control logic unit 12 which are provided by the user or system manufacturer. These applications can accordingly be created using available tools in the process control system and require no separate programming tools or knowledge. These include, in particular but not conclusively, the customization of data types or else specific command sequences in order to start units connected to the extraneous control unit 7.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 System bus
2 Field device
3 System control unit
4 Terminal bus
5 Engineering computer
6 Control station
7 Extraneous control unit
8 Control computer
9 I/O unit
10 OPC client
11 OPC server
12 Control logic unit
13 Function block

What is claimed is:

1. A process control system in an automation installation having field devices which are networked by means of a system bus and which can be operated using associated system control units which are connected by means of a terminal bus to at least one central engineering computer for configuring the system and to a central control station for monitoring and operating the system, wherein
for the purpose of linking at least one extraneous control unit to the terminal bus an interposed control computer is provided which, under software control, simulates a system-compliant I/O unit on the terminal bus, which I/O unit is bi-directionally connected to a software interface residing on the extraneous control unit.

2. The process control system as claimed in claim 1, wherein
the interface is in the form of an OPC client.

3. The process control system as claimed in claim 1, wherein
the OPC client integrated in the control computer has an associated OPC server, likewise integrated therein, as a communication interface to the extraneous control unit.

4. The process control system as claimed in claim 1, wherein
the terminal bus and the system bus are coupled to one another by means of a server architecture.

5. A control computer for incorporation into a process control system as claimed in claim 1,
which, under software control, simulates a system-compliant I/O unit on the terminal bus, which I/O unit is bi-directionally connected to an SW interface residing on the extraneous control unit.

6. The control computer as claimed in claim 5, wherein
it is in the form of a personal computer (PC) which, under software control, forms at least the system-compliant I/O unit and the OPC client.

7. The control computer as claimed in claim 6, wherein
a control logic unit on the terminal bus is implemented for the purpose of executing function blocks for the I/O unit.

8. A method for the software-controlled operation of a control computer as claimed in claim 5, wherein
a system-compliant I/O unit is simulated on the terminal bus, which I/O unit is bi-directionally connected to an OPC client residing on the extraneous control unit.

9. The method as claimed in claim 8, wherein
the type and instance relationships of the process control system are supported.

10. A computer program product for a control computer which can be operated on the basis of a method as claimed in claim 8, the routine for bi-directional connection being implemented by appropriate control commands stored in a piece of software.

11. A data storage medium with a computer program product as claimed in claim 10.

12. A control computer for incorporation into a process control system as claimed in claim 4,
which, under software control, simulates a system-compliant I/O unit on the terminal bus, which I/O unit is bi-directionally connected to an SW interface residing on the extraneous control unit.

13. A computer program product for a control computer which can be operated on the basis of a method as claimed in claim 9, the routine for bidirectional connection being implemented by appropriate control commands stored in a piece of software.

14. A process control system in an automation installation, comprising:
field devices which are networked based on a system bus;
system control units which are connected based on a terminal bus to at least one central engineering computer for configuring the system;
a central control station for monitoring and operating the system; and
a control computer interposed for the purpose of linking at least one extraneous control unit to the terminal bus, wherein, under software control, the interposed control computer simulates a system-compliant I/O unit on the terminal bus.

15. The process control system as claimed in claim 14, wherein said I/O unit is bi-directionally connected to a software interface residing on the extraneous control unit.
